(19) United States
(12) Patent Application Publication
(10) Pub. No.: US 2024/0157998 A1
(43) Pub. Date: May 16, 2024

(54) STEERING GEAR FOR A STEER-BY-WIRE STEERING SYSTEM

(71) Applicant: ZF Automotive Germany GmbH, Alfdorf (DE)

(72) Inventor: Eduard Span, Köln (DE)

(21) Appl. No.: 18/505,424

(22) Filed: Nov. 9, 2023

(30) Foreign Application Priority Data
Nov. 11, 2022 (DE) 102022211973.8

(51) Int. Cl. B62D 3/08; B62D 5/04; B62D 15/02

(52) U.S. Cl. CPC B62D 3/08; B62D 5/0409; B62D 5/0448; B62D 15/0225

(57) ABSTRACT

A steering gear for a steer-by-wire steering system of a motor vehicle has a slide rod which extends in an axial direction (Z) and which has a recirculating ball spindle and a rack with a toothing system, a drive portion which has a belt drive and a ball nut which is coupled to the recirculating ball spindle, a rotary supporting part which is configured to support a torque of the rack, and a sensor device which has a steering angle sensor and a sensor pinion which is coupled to the steering angle sensor. The sensor pinion is in toothed engagement with the toothing system in a portion which is arranged in the axial direction (Z) between a first axial end of the rotary supporting part and an opposite second axial end of the rotary supporting part.

### CROSS-REFERENCE TO RELATED APPLICATION

This application claims priority to German Priority Application No. 102022211973.8, filed Nov. 11, 2022, the disclosure of which is incorporated herein by reference in its entirety.

### TECHNICAL FIELD

The disclosure relates to a steering gear for a steer-by-wire steering system of a motor vehicle, with a slide rod which extends in an axial direction and which has a recirculating ball spindle and a rack with a toothing system, a drive portion which has a belt drive and a ball nut which is coupled to the recirculating ball spindle, a rotary supporting part which is configured to support a torque of the rack, and a sensor device which has a steering angle sensor and a sensor pinion which is coupled to the steering angle sensor.

### BACKGROUND

Steering systems usually comprise a slide rod which is mounted such that it can be displaced linearly for the adaptation of a wheel position. A slide rod of this type is originally coupled via a slide rod of this type to the steering wheel, with the result that a linear displacement of the slide rod is achieved via a rotation of the steering wheel.

In future, motor vehicles with what are known as steer-by-wire steering systems (SbW steering system) will increasingly be used, in the case of which there is no longer a mechanical connection between the steering wheel and the slide rod. The position of the steering wheel is detected electronically, and a corresponding displacement of the slide rod is achieved by an electric drive.

Here, the slide rod is part of a steering gear which is configured to mount the slide rod displaceably and to detect its displacement or deflection via a steering angle sensor.

One challenge in the design of steering gears for a steer-by-wire steering system consists in designing it to be particularly space-saving and at the same time ensuring a high functional reliability.

### SUMMARY

The present disclosure describes a steering gear for a steer-by-wire steering system which is of compact construction and has a high structural stability.

A steering gear for a steer-by-wire steering system of a motor vehicle can include a slide rod which extends in an axial direction and which has a recirculating ball spindle and a rack with a toothing system, a drive portion which has a belt drive and a ball nut which is coupled to the recirculating ball spindle, a rotary supporting part which is configured to support a torque of the rack, and a sensor device which has a steering angle sensor and a sensor pinion which is coupled to the steering angle sensor. The sensor pinion is in toothed engagement here with the toothing system in a portion which is arranged in the axial direction between a first axial end of the rotary supporting part and an opposite second axial end of the rotary supporting part.

It has been recognized according to the exemplary arrangement that the stability of the steering gear and, in particular, of the toothed engagement of the sensor pinion with the toothing system can be improved if the sensor pinion is integrated into the rotary supporting part or is arranged within the latter. Therefore, the steering gear has a high structural stability, as a result of which a high functional reliability is ensured. Furthermore, the steering gear can be of particularly compact design by way of this construction.

In particular, the sensor pinion does not form a drive pinion of the slide rod or rack here, that is to say the rack is not driven by way of the sensor pinion.

In an exemplary arrangement, the rotary supporting part is configured in one piece, as a result of which the strength and/or stability can be increased further.

It can be provided in addition or as an alternative that the portion, in which the sensor pinion is in toothed engagement with the toothing system, is arranged in the axial direction centrally between the first and the second axial end, in order to improve the stability of the steering gear.

Furthermore, the external diameter of the sensor pinion is at most 20 mm, as a result of which the sensor pinion and therefore the steering gear are of particularly compact design with a low mass.

In accordance with an exemplary arrangement, the sensor pinion is formed at least partially from a plastic, in order to keep the mass of the steering gear low.

Here, the sensor pinion can be formed completely from plastic. This has the advantage that the sensor pinion can be produced particularly inexpensively and with a low mass.

In another exemplary arrangement, the sensor pinion can have a metal core and can therefore be formed only partially from plastic. As a result of the metal core, the sensor pinion has a particularly high strength.

In accordance with another exemplary arrangement, the rack has a cross section in the form of a polygon in the portion, in which the toothing system is arranged. In this way, high torques which act on the rack in the circumferential direction about their longitudinal axis can be supported by the rotary supporting part, in particular if the rotary supporting part is of complementary design.

Here, the cross section can have the shape of a regular polygon. This symmetrical design has the advantages that the torques can be supported particularly effectively and the manufacturing complexity is decreased.

In particular, the cross section can have a hexagonal or octagonal shape which ensures a high bending strength of the rack. Furthermore, only a comparatively small removal of material is required in the case of machining in order to produce a hexagonal or octagonal cross section of this type, with the result that the slide rod can be produced with less complexity.

### BRIEF DESCRIPTION OF DRAWINGS

Further advantages and features result from the following description and from the appended drawings, in which:

FIG. 1 shows a diagrammatic illustration of a steering gear according to the disclosure with a slide rod and a radial supporting part,

FIG. 2 shows a plan view of the steering gear from FIG. 1 without the radial supporting part,

FIG. 3 shows a sectional view of the steering gear from FIG. 1, the sectional plane running through the slide rod and a sensor pinion of the steering gear,

FIG. 4 shows a detailed view of the sensor pinion and a rotary supporting part of the steering gear from FIG. 1, and

FIG. 5 shows the steering gear in a sectional view along the plane N-N in FIG. 2.

### DETAILED DESCRIPTION

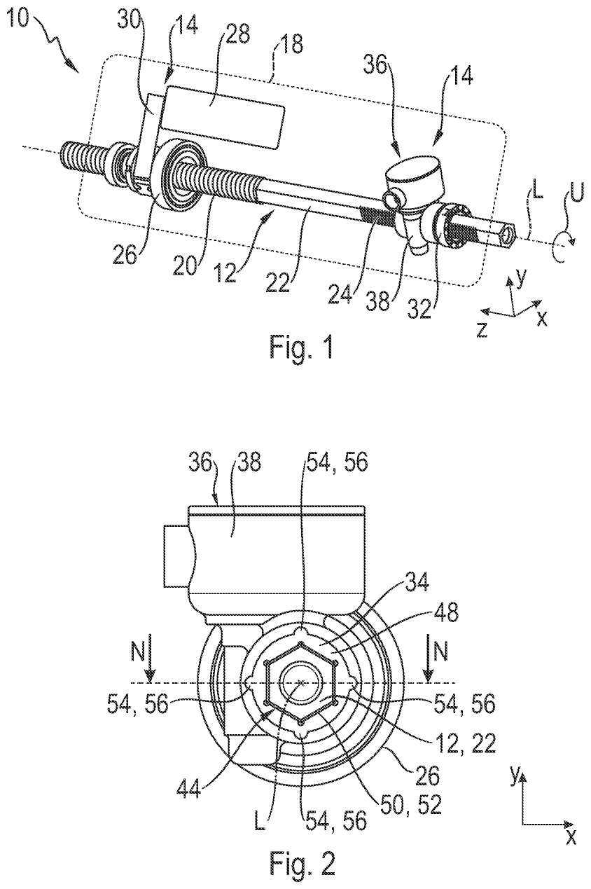

FIG. 1 shows a steering gear 10 for a steer-by-wire steering system of a motor vehicle, which steering gear 10 has a slide rod 12, a drive portion 14 and a supporting portion 16.

Furthermore, the steering gear 10 has a steering gear housing 18, in which the slide rod 12, the drive portion 14 and the supporting portion 16 are received at least in sections and which is configured to fasten the abovementioned components to an associated component of the motor vehicle. In this way, these components are attached fixedly to the vehicle at the assigned component via the steering gear housing 18 in the mounted state.

The slide rod 12 extends in an axial direction Z along the longitudinal axis L and is mounted axially displaceably in the steering gear housing 18.

In this context, the slide rod 12 has an axial portion in the form of a recirculating ball spindle 20 and a further axial portion in the form of a rack 22 with a toothing system 24.

The drive portion 14 is configured to displace the slide rod 12 axially in the steering gear housing 18 and, to this end, has a ball nut 26 which is coupled to the recirculating ball spindle 20, a belt drive 28 and a belt 30 which connects the belt drive 28 to the ball nut 26 in a torque-transmitting manner.

The supporting portion 16 is configured to stabilize or to stably mount the slide rod 12 in the steering gear housing 18 and, to this end, has a radial supporting part 32 which supports the slide rod 12 in the axial direction with respect to the steering gear housing 18, and a rotary supporting part 34 (see FIG. 2) which supports torques which act on the slide rod 12 in the circumferential direction U.

Here, the rotary supporting part 34 is arranged on the axial portion of the rack 22 which has the toothing system 24.

In order to detect the axial position of the slide rod 12 and therefore the steering angle or the orientation of the wheels of the motor vehicle which are coupled to the slide rod 12, the steering gear 10 has a sensor device 36 with a sensor housing 38, a sensor pinion 40 (see FIG. 4) and a steering angle sensor 42.

In this context, the sensor pinion 40 is into engagement with the toothing system 24 of the rack 22, as a result of which the sensor pinion 40 rotates about a rotational axis R when the push rod 12 is displaced in the axial direction Z.

In the present exemplary arrangement, the sensor pinion 40 has an external diameter D of 14 mm and consists completely of plastic.

In another exemplary arrangement, the external diameter D of the sensor pinion 40 is at most 20 mm.

Furthermore, the sensor pinion 40 can fundamentally be formed from any desired material.

In an exemplary arrangement, the sensor pinion 40 is formed at least partially from plastic and/or has a metal core.

The steering angle sensor 42 is coupled fixedly to the sensor pinion 40 for conjoint rotation and is configured in a known way to determine the axial position of the slide rod 12 via the rotation of the sensor pinion 40. To this end, the steering angle sensor 42 can have further components which are not shown in the figures.

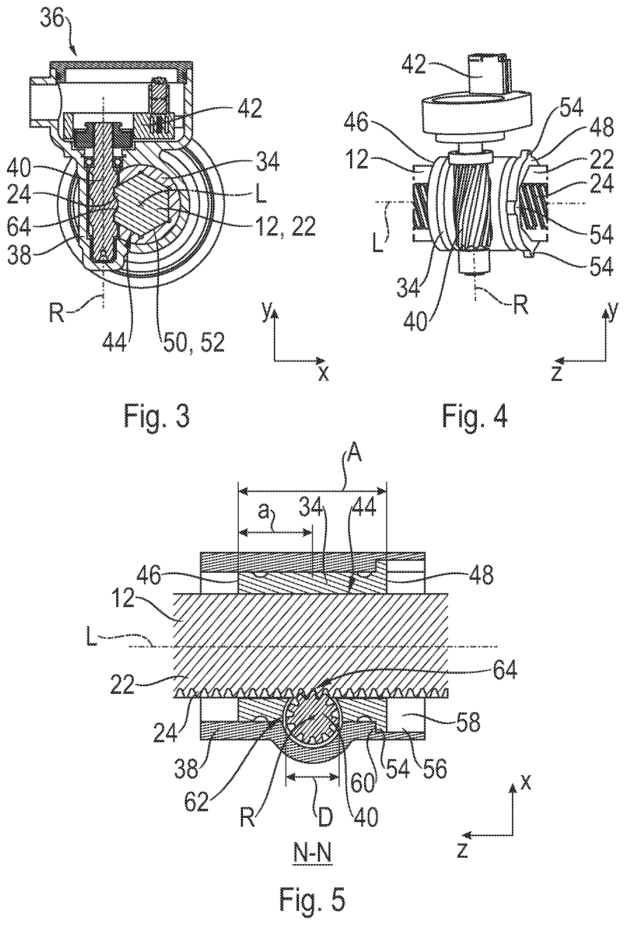

Here, the sensor device 36 is integrated into the supporting portion 16, as is explained in the following text on the basis of FIGS. 2 to 5.

The rotary supporting part 34 is configured in the form of a bushing, and has a channel 44 which extends from a first axial end 46 to an opposite second axial end 48 of the rotary supporting part 34.

In the present exemplary arrangement, the rotary supporting part 34 is configured in one piece.

In another exemplary arrangement, the rotary supporting part 34 can consist of a plurality of parts.

In all exemplary arrangements, the channel 44 is of complementary design at least in portions with respect to the rack 22. More precisely, the cross section 50 of the channel 44 is of complementary design at least in portions with respect to the cross section 52 of the rack 22, as shown in FIG. 2. The toothing system 24 remains unconsidered for the complementary design, that is to say the rotary supporting part 34 is not into engagement with the toothing system 24, in order not to impede the axial displaceability of the slide rod 12.

In the exemplary arrangement which is shown, the rack 22 has a hexagonal cross section 52.

The rack 22 can fundamentally have any desired, non-circular cross section 52.

In an exemplary arrangement, the cross section 52 of the rack 22 has the shape of a polygon, in particular of a regular polygon, for example of a regular octagon.

Furthermore, the rotary supporting part 34 has radial projections 54 which engage into recesses 56 (see FIG. 2) of complementary design of the sensor housing 38, by way of which the rotary supporting part 34 is coupled fixedly to the sensor housing 38 for conjoint rotation.

It goes without saying that, in another exemplary arrangement, the rotary supporting part 34 can have merely one radial projection 54 which engages into a recess 56 of complementary design.

In addition or as an alternative, the projections 54 and the recesses 56 of complementary design can each be designed in any desired manner as long as they couple the rotary supporting part 34 to the sensor housing 38 fixedly for conjoint rotation.

Here, the recesses 56 are part of a receptacle 58 (see FIG. 5) in the sensor housing 38, in which receptacle 58 the rotary supporting part 34 is received or arranged completely.

In another exemplary arrangement, the rotary supporting part 34 is arranged at least in portions in the receptacle 58 or in the sensor housing 38.

As shown in FIGS. 2 and 5, the receptacle 58 is of complementary design at least in portions with respect to the rotary supporting part 34, as a result of which the rotary supporting part 34 is received at least in portions in a positively locking manner in the sensor housing 38 in the radial direction, that is to say perpendicularly with respect to the axial direction Z, and in the circumferential direction U, and is therefore mounted in a stable manner in this sensor housing 38.

Furthermore, the sensor housing 38 is designed in such a way that the rotary supporting part 34 can be pushed into the receptacle 58 in the axial direction Z.

In this way, that portion of the sensor housing 38 which comprises a receptacle 58 can be configured in one piece, as a result of which the sensor housing 38 can be produced particularly inexpensively.

Here, the radial projections 54 and the recesses 56 form an axial stop 60 (see FIG. 5) which ensures a defined axial arrangement of the rotary supporting part 34 in the receptacle 58.

In this context, the sensor housing 38 is connected rigidly to the steering gear housing 18 and/or is configured to be attached rigidly to a component of the motor vehicle, with the result that, in the mounted state, the sensor housing 38 is fastened directly or at least indirectly fixedly on the vehicle to an associated component of the motor vehicle.

Here, the sensor pinion 40 extends into the receptacle 58 and engages in the channel 44 of the rotary supporting part 34 into the toothing system 24 of the rack 22 which extends in the axial direction Z through the receptacle 58.

To this end, the rotary supporting part 34 has a through opening 62 (see FIG. 5) which extends radially through the rotary supporting part 34 from the channel 44 at a location between the first and the second axial end 46, 48.

This means that the sensor pinion 40 is into engagement with the toothing system 24 in the channel 44 via the through opening 62 in a portion 64 between the first and the second axial end 46, 48 of the rotary supporting part 34.

In the present exemplary arrangement, the axial spacing a between the first axial end 46 and the rotational axis R of the sensor pinion 40 is half the axial spacing A between the first axial end 46 and the second axial end 48 of the rotary supporting part 34. In other words, the sensor pinion 40 and therefore the portion 64 are arranged in the axial direction Z centrally between the first axial end 46 and the second axial end 48.

In another exemplary arrangement, the portion 64, in which the sensor pinion 40 is in toothed engagement with the toothing system 24, can be arranged at any desired location in the axial direction Z between the first axial end 46 and the second axial end 48 of the rotary supporting part 34.

In this way, a steering gear 10 is provided which is of particularly compact construction.

Furthermore, the design of the supporting portion 16 ensures that the sensor pinion 40 remains reliably in toothed engagement with the toothing system 24, in particular independently of loads which act on the rack 22.

Therefore, a high functional reliability of the steering angle sensor 42 and therefore of the steering gear 10 is ensured.

The disclosure is not restricted to the exemplary arrangement which is shown. In particular, individual features of one exemplary arrangement can be combined in any desired way with features of other exemplary arrangements, in particular independently of the other features of the corresponding exemplary arrangements.

1. A steering gear for a steer-by-wire steering system of a motor vehicle, with a slide rod which extends in an axial direction (Z) and which has a recirculating ball spindle and a rack with a toothing system, a drive portion which has a belt drive and a ball nut which is coupled to the recirculating ball spindle, a rotary supporting part which is configured to support a torque of the rack, and a sensor device which has a steering angle sensor and a sensor pinion which is coupled to the steering angle sensor, wherein the sensor pinion is in toothed engagement with the toothing system in a portion which is arranged in the axial direction (Z) between a first axial end of the rotary supporting part and an opposite second axial end of the rotary supporting part.

2. The steering gear according to claim 1, wherein the rotary supporting part is configured in one piece.

3. The steering gear according to claim 1, wherein the portion, in which the sensor pinion is in toothed engagement with the toothing system, is arranged in the axial direction (Z) centrally between the first and the second axial end.

4. The steering gear according to claim 1, wherein an external diameter (D) of the sensor pinion is at most 20 mm.

5. The steering gear according to claim 1, wherein the sensor pinion is formed at least partially from a plastic.

6. The steering gear according to claim 5, wherein the sensor pinion is formed completely from plastic.

7. The steering gear according to claim 5, wherein the sensor pinion has a metal core.

8. The steering gear according to claim 1, wherein the rack has a cross section in the form of a polygon in the portion, in which the toothing system is arranged.

9. The steering gear according to claim 8, wherein the cross section has the shape of a regular polygon.

10. The steering gear according to claim 9, wherein the cross section has a hexagonal or octagonal shape.

11. A steering gear for a steer-by-wire steering system of a motor vehicle, the steering gear comprising:
a slide rod extending in an axial direction (Z) and including a ball spindle and a rack with a toothing system;
a drive portion including a belt drive and a ball nut coupled to the ball spindle;
a rotary supporting part configured to support a torque of the rack; and
a sensor device including a steering angle sensor and a sensor pinion coupled to the steering angle sensor, wherein the sensor pinion is in toothed engagement with the toothing system in a portion that is arranged in the axial direction (Z) between a first axial end of the rotary supporting part and an opposite second axial end of the rotary supporting part.

12. The steering gear according to claim 11, wherein the rotary supporting part is configured in one piece.

13. The steering gear according to claim 11, wherein a portion, in which the sensor pinion is in toothed engagement with the toothing system, is arranged in the axial direction (Z) centrally between the first and the second axial end.

14. The steering gear according to claim 11, wherein an external diameter (D) of the sensor pinion is at most 20 mm.

15. The steering gear according to claim 11, wherein the sensor pinion is formed at least partially from a plastic.

16. The steering gear according to claim 15, wherein the sensor pinion is formed completely from plastic.

17. The steering gear according to claim 15, wherein the sensor pinion comprises a metal core.

18. The steering gear according to claim 11, wherein the rack has a cross section in the form of a polygon in the portion in which the toothing system is arranged.

19. The steering gear according to claim 18, wherein the cross section has the shape of a regular polygon.

20. The steering gear according to claim 19, wherein the cross section comprises at least one of a hexagonal or a octagonal shape.
